(19) United States
(12) Patent Application Publication
(10) Pub. No.: US 2022/0403488 A1
(43) Pub. Date: Dec. 22, 2022

(54) HIGH-PERMEABILITY FERRITE-BASED STAINLESS STEEL

(71) Applicant: POSCO, Pohang-si, Gyeongsangbuk-do (KR)

(72) Inventors: Jieon Park, Pohang-si, Gyeongsangbuk-do (KR); Hyung-gu Kang, Pohang-si, Gyeongsangbuk-do (KR); Kyung-hun Kim, Pohang-si, Gyeongsangbuk-do (KR)

(73) Assignee: POSCO, Pohang-si, Gyeongsangbuk-do (KR)

(21) Appl. No.: 17/777,466

(22) PCT Filed: Jul. 8, 2020
(86) PCT No.: PCT/KR2020/008943

§ 371 Date: May 17, 2022

(30) Foreign Application Priority Data
Nov. 19, 2019 (KR) 10-2019-0148223

(51) Int. Cl. C22C 38/26; C22C 38/00; C22C 38/02; C21D 8/12

(52) U.S. Cl. CPC C22C 38/26; C22C 38/001; C22C 38/004; C22C 38/02; C21D 8/12; C21D 2211/005

(57) ABSTRACT

Disclosed is a high-permeability ferrite-based stainless steel. According to an embodiment, the disclosed high-permeability ferrite-based stainless steel includes, in percent by weight (wt %), 0.0005 to 0.02% of C, 0.005 to 0.02% of N, 0.2 to 2.0% of Si, 10.0 to 25.0% of Cr, 0.05 to 0.5% of Nb, and the remainder of Fe and other inevitable impurities, wherein a Nb/(C+N) value satisfies a range of 5 to 20 and a <001>//RD texture fraction is 5% or more.

### TECHNICAL FIELD

The present disclosure relates to a high-permeability ferrite-based stainless steel, and more particularly, to a high-permeability ferrite-based stainless steel capable of shielding elements in various electronic devices against electromagnetic waves.

### BACKGROUND ART

Elements for diverse purposes are used in a variety of electronic devices, and these elements may malfunction or it may be difficult to precisely control these elements due to electromagnetic interference of surrounding environments. In order to prevent malfunction of electronic devices due to electromagnetic interference, important elements need to be surrounded by a material capable of blocking magnetic fields.

Various materials capable of blocking magnetic fields have been developed. However, in order to operate various electronic devices without malfunction even under diverse environments where electromagnetic interface occurs, the demand for materials capable of blocking magnetic fields as well as excellent corrosion resistance has been increased, recently.

As a representative example of materials having excellent magnetic properties and corrosion resistance, ferrite-based stainless steels may be used. However, magnetic permeability of conventional ferrite-based stainless steels is insufficient for blocking magnetic fields.

### DISCLOSURE

### Technical Problem

To solve the above-described problems, provided is a high-permeability ferrite-based stainless steel capable of shielding elements in various electronic devices against electromagnetic waves.

### Technical Solution

In accordance with an aspect of the present disclosure, a high-permeability ferrite-based stainless steel includes, in percent by weight (wt %), 0.0005 to 0.02% of C, 0.005 to 0.02% of N, 0.2 to 2.0% of Si, 10.0 to 25.0% of Cr, 0.05 to 0.5% of Nb, and the remainder of Fe and other inevitable impurities, wherein a Nb/(C+N) value satisfies a range of 5 to 20 and a <001>//RD texture fraction is 5% or more.

In the high-permeability ferrite-based stainless steel according to the present disclosure, the Nb/(C+N) value may satisfy a range of 5 to 15.

In the high-permeability ferrite-based stainless steel according to the present disclosure, an average particle diameter of grains may be from 50 to 200 μm.

In the high-permeability ferrite-based stainless steel according to the present disclosure, a magnetic permeability may be 1200 or more, when a magnetic field of 10000 A/m is applied at a frequency of 50 Hz.

In the high-permeability ferrite-based stainless steel according to the present disclosure, a yield strength may be 280 MPa or more.

### Advantageous Effects

According to the present disclosure, a ferrite-based stainless steel having excellent corrosion resistance and high magnetic permeability may be provided.

According to the present disclosure, a ferrite-based stainless steel having high magnetic permeability may be provided by adjusting an average particle diameter of grains and a texture by controlling a composition of alloying elements of the steel and processing conditions.

### DESCRIPTION OF DRAWINGS

FIG. 1 shows orientation distribution function (ODF) of textures of final cold-rolled, annealed materials according to Comparative Example 2 and Inventive Example 8. FIG. 1a is an ODF according to Comparative Example 2, and FIG. 1b is an ODF according to Inventive Example 8.

### BEST MODE

A high-permeability ferrite-based stainless steel according to an embodiment of the present disclosure includes, in percent by weight (wt %), 0.0005 to 0.02% of C, 0.005 to 0.02% of N, 0.2 to 2.0% of Si, 10.0 to 25.0% of Cr, 0.05 to 0.5% of Nb, and the remainder of Fe and other inevitable impurities, wherein a Nb/(C+N) value satisfies a range of 5 to 20 and a <001>//RD texture fraction is 5% or more.

### Modes of the Invention

Hereinafter, preferred embodiments of the present disclosure will now be described. However, the present disclosure may be embodied in many different forms and should not be construed as being limited to the embodiments set forth herein. Rather, these embodiments are provided so that this disclosure will be thorough and complete, and will fully convey the scope of the disclosure to those skilled in the art.

The terms used herein are merely used to describe particular embodiments. Thus, an expression used in the singular encompasses the expression of the plural, unless it has a clearly different meaning in the context. In addition, it is to be understood that the terms such as “including” or “having” are intended to indicate the existence of features, steps, functions, components, or combinations thereof disclosed in the specification, and are not intended to preclude the possibility that one or more other features, steps, functions, components, or combinations thereof may exist or may be added.

Meanwhile, unless otherwise defined, all terms used herein have the same meaning as commonly understood by one of ordinary skill in the art to which this disclosure belongs. Thus, these terms should not be interpreted in an idealized or overly formal sense unless expressly so defined herein. As used herein, the singular forms are intended to include the plural forms as well, unless the context clearly indicates otherwise.

In addition, the terms “about”, “substantially”, etc. used throughout the specification mean that when a natural manufacturing and substance allowable error are suggested, such an allowable error corresponds a value or is similar to the value, and such values are intended for the sake of clear understanding of the present invention or to prevent an unconscious infringer from illegally using the disclosure of the present invention.

In addition, as used herein, the term “<001>//RD texture” refers to a texture having a crystal orientation of a rolling direction parallel to the <001> axis.

A ferrite-based stainless steel having excellent magnetic properties according to an embodiment of the present disclosure may include, in percent by weight (wt %), 0.0005 to 0.02% of C, 0.005 to 0.02% of N, 0.2 to 2.0% of Si, 10.0 to 25.0% of Cr, 0.05 to 0.5% of Nb, and the remainder of Fe and other inevitable impurities.

Hereinafter, reasons for numerical limitations on the contents of alloying elements in the embodiment of the present disclosure will be described. Hereinafter, the unit is wt % unless otherwise stated.

Carbon (C): 0.0005 to 0.02 wt %

Because carbon (C) is an impurity element unavoidably contained in steels, it is preferable to control the C content as low as possible. However, when the C content is less than 0.0005 wt %, refining costs may increase due to a too low C content, and thus the C content may be controlled to be 0.0005 wt % or more in the present disclosure. However, an excess of the C content increases impurities to deteriorate elongation, decreases a work hardening index (n value), and increases a ductile brittle transition temperature (DBTT) resulting in deterioration of impact properties. Therefore, an upper limit of the C content is set to 0.02 wt % in the present disclosure. In consideration of processibility and mechanical properties, the upper limit of the C content may preferably be set to 0.01 wt %.

Nitrogen (N): 0.005 to 0.02 wt %

When the N content is less than 0.005 wt %, a crystallization amount of TiN decreases to reduce an equiaxed crystal ratio of a slab, and thus nitrogen may be added in an amount of 0.005 wt % or more in the present disclosure. However, an excess of N increases impurities in a material to deteriorate elongation and increases a ductile brittle transition temperature (DBTT) resulting in deterioration of impact properties. Therefore, an upper limit of the N content is set to 0.02 wt % in the present disclosure. In consideration of processibility and mechanical properties, the upper limit of the N content may preferably be set to 0.015 wt %.

Silicon (Si): 0.2 to 2.0 wt %

Silicon (Si) is an element added to increase strength of a steel. In order to obtain a desired strength, silicon may be added in an amount of 0.2 wt % or more in the present disclosure. However, an excess of silicon deteriorates elongation, decreases a work hardening index (n value), increases Si-based inclusions resulting in deterioration of processibility. Therefore, an upper limit of the Si content is set to 2.0 wt % in the present disclosure. In consideration of processibility, the upper limit of the Si content may preferably be set to 1.0 wt %.

Chromium (Cr): 10.0 to 25.0 wt %

Chromium (Cr) is the most important element added to obtain corrosion resistance of a stainless steel. Chromium may be added in an amount of 10.0 wt % or more to obtain corrosion resistance in the present disclosure. To obtain corrosion resistance, chromium may preferably be added in an amount of 15.0 wt %. However, an excess of chromium deteriorates elongation and causes a sticking defect during hot rolling, and therefore an upper limit of the Cr content is set to 25.0 wt %. In consideration of processibility and mechanical properties, the upper limit of the Cr content may preferably be set to 20.0 wt %.

Niobium (Nb): 0.05 to 0.5 wt %

Niobium (Nb) is an element forming a solid solution to increase strength of a steel and preferentially binding to carbon (C) and nitrogen (N), which deteriorate corrosion resistance, to form stable Nb-based precipitates, thereby improving corrosion resistance. In addition, niobium forms Nb-based precipitates, when added, thereby preventing grains from excessively coarsening and promotes the growth of a <001>//RD texture having an orientation favorable for magnetization, thereby increasing a <001>//RD texture fraction. As a result, niobium has an effect on improving magnetic properties, when added. In the present disclosure, for the purpose of increasing strength, improving corrosion resistance, and enhancing magnetic properties, niobium may be added in an amount of 0.05 wt % or more.

However, when the Nb content is excessive, niobium binding to carbon and nitrogen forms excess of Nb-based precipitates, and thus an average diameter of grains cannot be sufficiently increased. In the case where the diameter of the grains is not sufficiently increased, magnetization is inhibited by grain boundaries failing to obtain desired magnetic permeability. In addition, when the Nb content is excessive, the amount of solute Nb not binding to C and N increases in a steel, failing to obtain a sufficient fraction of the <001>//RD texture favorable for magnetization. In consideration thereof, an upper limit of the Nb content is set to 0.5 wt % in the present disclosure. For the purpose of obtaining high magnetic permeability, the upper limit of the Nb content may preferably be set to 0.25 wt %.

The remaining component of the composition of the present disclosure is iron (Fe). However, the composition may include unintended impurities inevitably incorporated from raw materials or surrounding environments, and thus addition of other alloy components is not excluded. The impurities are not specifically mentioned in the present disclosure, as they are known to any person skilled in the art of manufacturing.

The high-permeability ferrite-based stainless steel according to the present disclosure has high magnetic permeability and excellent corrosion resistance. In order to obtain high magnetic permeability and excellent corrosion resistance, it is important to control the amount of Nb-based precipitates formed by combination of niobium, carbon, and nitrogen. Accordingly, the present inventors have derived an Nb/(C+N) parameter expressed by a ratio of the Nb content to the (C+N) content, and the amount of Nb-based precipitates is adjusted based on the parameter. In this regard, each of the Nb, C, and N indicates wt % of each alloying element.

According to an embodiment of the present disclosure, the Nb/(C+N) value may be from 5 to 20. When the Nb/(C+N) value is less than 5, niobium cannot sufficiently remove carbon and nitrogen, which deteriorate corrosion resistance, thereby deteriorating corrosion resistance. In addition, too coarse grains are formed due to the insufficiently formed Nb-based precipitates, and thus the yield strength decreases and the <001>//RD texture fraction cannot be sufficiently obtained, thereby deteriorating magnetic permeability.

On the contrary, when the Nb/(C+N) value exceeds 20, the amount of solute Nb not binding to C and N increases in a steel, failing to obtain a sufficient fraction of the <001>//RD texture favorable for magnetization and desired magnetic permeability cannot be obtained due to insufficient average diameter of grains. In addition, in order to obtain high magnetic permeability and excellent corrosion resistance, the Nb/(C+N) value may preferably be from 5 to 15, more preferably, from 8 to 15.

The <001>//RD texture is a texture having a crystal orientation of a rolling direction parallel to the <001> axis. The present disclosure provides a high-permeability ferrite-based stainless steel having improved magnetic properties by controlling the fraction of the <001>//RD texture favorable for magnetization at a certain level or more.

The <001>//RD texture fraction of the high-permeability ferrite-based stainless steel according to an embodiment of the present disclosure may be 5% or more. When the <001>//RD texture fraction is less than 5%, a high magnetic permeability of 1200 or more intended to obtain in the present disclosure cannot be obtained by applying a magnetic field of 10000 A/m at a frequency of 50 Hz.

An average particle diameter of grains of the high-permeability ferrite-based stainless steel according to the present disclosure may be from 50 to 200 μm. When the average particle diameter of the grains is less than 50 μm, magnetization is inhibited by grain boundaries, failing to obtain desired magnetic permeability. When the average particle diameter of the grains is greater than 200 μm, the yield strength may decrease.

The average particle diameter of the grains may be controlled by a composition of alloying elements or processing conditions such as reheating temperature of a slab, reduction ratio during cold rolling, temperature during annealing heat treatment, heating rate, and time. However, it should be noted that these conditions are examples for the sake of clear understanding of the method of controlling the average particle diameter of grains and not intended to limit the scope of the present disclosure. The average particle diameter of the grains may be adjusted in various manners by controlling the composition of alloying elements or the processing conditions.

The high-permeability ferrite-based stainless steel according to the present disclosure satisfying the composition of alloying elements, the <001>//RD texture fraction, and the average particle diameter range of grains proposed by the present disclosure has excellent corrosion resistance, high magnetic permeability, and high yield strength.

The magnetic permeability of the high-permeability ferrite-based stainless steel according to an embodiment of the present disclosure may be 1200 or more when a magnetic field of 10000 A/m is applied at a frequency of 50 Hz.

The high-permeability ferrite-based stainless steel according to an embodiment of the present disclosure may have a yield strength of 280 MPa or more.

Hereinafter, the present disclosure will be described in more detail through examples. However, it is necessary to note that the following examples are only intended to illustrate the present disclosure in more detail and are not intended to limit the scope of the present disclosure. This is because the scope of the present disclosure is determined by matters described in the claims and able to be reasonably inferred therefrom.

### EXAMPLES

Steels having the following chemical compositions shown in Table 1 below were cast to obtain slabs, and the slabs were re-heated at a temperature of 1,100 to 1,300° C. The re-heated slabs were hot-rolled, cold-rolled, and annealed to obtain final cold-rolled products.

The Nb/(C+N) values of Table 1 were obtained by substituting the contents (wt %) of the alloying elements Nb, C, and N.

TABLE 1

| | Composition of alloying elements (wt %) | | | | | |
|---|---|---|---|---|---|---|
| Steel type | C | N | Si | Cr | Nb | Nb/(C + N) |
| A | 0.0124 | 0.0157 | 0.4 | 18.1 | 0.53* | 18.9 |
| B | 0.0074 | 0.0153 | 0.6 | 16.2 | 0.65* | 28.6* |
| C | 0.0067 | 0.0119 | 0.1* | 18.4 | 0.22 | 11.8 |
| D | 0.0098 | 0.0087 | 2.5* | 16.2 | 0.24 | 13.0 |
| E | 0.0123 | 0.0102 | 0.4 | 16.3 | 0.02* | 0.9* |
| F | 0.0072 | 0.0090 | 0.4 | 18.3 | 0.23 | 14.2 |
| G | 0.0066 | 0.0110 | 0.6 | 16.1 | 0.17 | 9.7 |

*(is out of the range defined by the present disclosure.)

Table 2 shows steel types, average particle diameters (μm) of grains, <001>//RD texture fractions (%), magnetic permeabilities, yield strength (MPa) values of respective examples.

The average particle diameters of grains and the <001>//RD texture fractions shown in Table 2 were measured using an electron back scatter diffraction (EBSD) detector. The magnetic permeability of each steel type having a thickness of 0.5 mm was measured by applying a magnetic field of 10000 A/m at a frequency of 50 Hz. For the yield strength, 0.2% off-set yield strength was measured by performing a tensile test on a sample according to the JIS13B standards in a direction perpendicular to the rolling direction at room temperature.

TABLE 2

| | | Average | | | |
|---|---|---|---|---|---|
| | | particle | <001>//RD | | Yield |
| | Steel | diameter of | texture | Magnetic | strength |
| Example | type | grains (μm) | fraction (%) | permeability | (MPa) |
| Inventive | F | 119.6 | 7.2 | 1271 | 291 |
| Example 1 | | | | | |
| Inventive | F | 79.6 | 12.2 | 1342 | 305 |
| Example 2 | | | | | |
| Inventive | G | 152.1 | 8.3 | 1354 | 287 |
| Example 3 | | | | | |
| Comparative | A | 37.1* | 6.2 | 678* | 347 |
| Example 1 | | | | | |
| Comparative | B | 40.3* | 1.1* | 459* | 339 |
| Example 2 | | | | | |
| Comparative | C | 67.4 | 6.5 | 1233 | 266* |
| Example 3 | | | | | |
| Comparative | D | Break during cold rolling | | | |
| Example 4 | | | | | |
| Comparative | E | 223.7* | 2.7* | 1023* | 237* |
| Example 5 | | | | | |
| Comparative | F | 23.4* | 5.9 | 572* | 334 |
| Example 6 | | | | | |
| Comparative | G | 37.4* | 6.7 | 854* | 317 |
| Example 7 | | | | | |
| Comparative | G | 276.9* | 26.9 | 1572 | 257* |
| Example 8 | | | | | |

*(is out of the range defined by the present disclosure.)

Hereinafter, Inventive Examples and Comparative Examples will be comparatively evaluated based on Tables 1 and 2 and the accompanying drawings.

Since Inventive Examples 1 to 3 satisfy the composition range of alloying elements, the average particle diameter range of grains, and the <001>//RD texture fraction range defined by the present disclosure, a magnetic permeability of 1200 or more and a yield strength of 280 MPa or more were obtained in the case of applying a magnetic field of 10000 A/m at a frequency of 50 Hz.

In Comparative Examples 1 and 2, the Nb content exceeded the upper limit of 0.5 wt % defined in the present disclosure. As a result, excess of Nb-based precipitates was formed, and the average particle diameter of grains was less than 50 μm. Particularly, in Comparative Example 2, not only the Nb content is excessive, but also the Nb/(C+N) value exceeded the upper limit of 20 defined in the present disclosure. According to Comparative Example 2, the fraction of the <001>//RD texture favorable for magnetization was 1.1%, which is not sufficient, due to the high Nb content relative to the (C+N) content. Because the average particle diameter of grains of Comparative Example 1 was out of the range defined in the present disclosure, and the average particle diameter of grains and the fraction of the <001>//RD texture of Comparative Example 2 were out of the ranges defined in the present disclosure, it was not possible to obtain the magnetic permeability intended to obtain in the present disclosure.

In Comparative Example 3, the Si content was less than the lower limit of 0.2 wt % defined in the present disclosure. As a result, it was not possible to obtain a yield strength intended to obtain in the present disclosure. In Comparative Example 4, the Si content exceeded the upper limit of 2.0 wt % defined by the present disclosure. The steel type of Comparative Example 4 broke during cold rolling due to low processibility decreased by an excessive Si content.

In Comparative Example 5, the Nb content was less than the lower limit of 0.05 wt % defined in the present disclosure, and the Nb/(C+N) value was less than the lower limit of 5 defined in the present disclosure. As a result, the Nb-based precipitates were not sufficiently formed and thus the grains excessively coarsened, resulting in a decrease in the yield strength, and the insufficient <001>//RD texture fracture caused deterioration of magnetic permeability.

In Comparative Example 6, although the same steel type F as those of Inventive Examples 1 and 2 was used, the average particle diameter of the grains was less than the lower limit of 50 μm defined in the present disclosure. As a result, magnetization was inhibited by grain boundaries, failing to obtain a magnetic permeability intended to obtain in the present disclosure.

In Comparative Example 7, although the same steel type G as that of Inventive Example 3 was used, the average particle diameter of the grains was less than the lower limit of 50 μm defined in the present disclosure. As a result, magnetization was inhibited by grain boundaries, failing to obtain a magnetic permeability intended to obtain in the present disclosure.

In Comparative Example 8, although the same steel type G as that of Inventive Example 3 was used, the average particle diameter of the grains was greater than the upper limit of 200 μm defined in the present disclosure. As a result, a yield strength intended to obtain in the present disclosure could not be obtained.

Hereinafter, each of the examples will be evaluated with reference to the accompanying drawings.

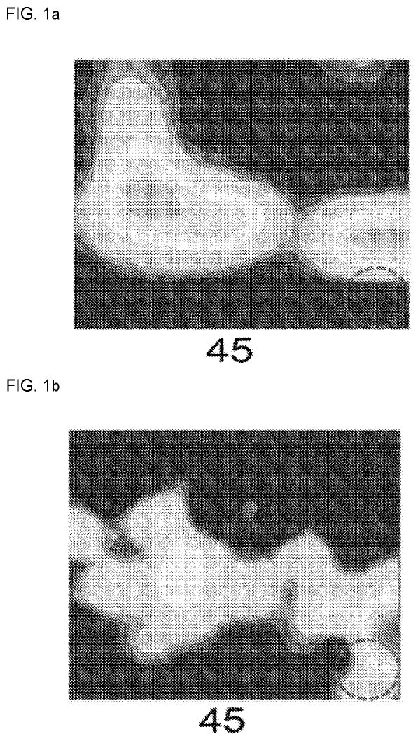

FIG. 1 shows orientation distribution function (ODF) of textures of final cold-rolled, annealed materials according to Comparative Example 2 and Inventive Example 8. FIG. 1a is an ODF according to Comparative Example 2, and FIG. 1b is an ODF according to Inventive Example 8. Circles marked by dotted lines in FIGS. 1a and 1b indicate the <001>//RD textures. Upon comparison between FIGS. 1a and 1b, it may be visually confirmed that the <001>//RD texture fraction of Inventive Example 8 is significantly higher than that of Comparative Example 2.

Based on the above-described results, it may be confirmed that a high-permeability ferrite-based stainless steel having a magnetic permeability of 1200 or more and a yield strength of 280 MPa or more may be obtained in the case of applying a magnetic field of 10000 A/m at a frequency of 50 Hz, when the Nb/(C+N) is controlled in the range of 5 to 20 in the alloying elements, the <001>//RD texture fraction is controlled to be 5% or more, and the average particle diameter of grains is controlled in the range of 50 to 200 μm as defined in the present disclosure.

While the present disclosure has been particularly described with reference to exemplary embodiments, it should be understood by those of skilled in the art that various changes and modifications in form and details may be made without departing from the spirit and scope of the present disclosure.

### INDUSTRIAL APPLICABILITY

The ferrite-based stainless steel according to the present disclosure may be applied to a material for shielding elements in various electronic devices against electromagnetic waves.

1. A high-permeability ferrite-based stainless steel comprising, in percent by weight (wt %), 0.0005 to 0.02% of C, 0.005 to 0.02% of N, 0.2 to 2.0% of Si, 10.0 to 25.0% of Cr, 0.05 to 0.5% of Nb, and the remainder of Fe and other inevitable impurities,
wherein a Nb/(C+N) value satisfies a range of 5 to 20, and
a <001>//RD texture fraction is 5% or more.

2. The high-permeability ferrite-based stainless steel according to claim 1, wherein the Nb/(C+N) value satisfies a range of 5 to 15.

3. The high-permeability ferrite-based stainless steel according to claim 1, wherein an average particle diameter of grains is from 50 to 200 μm.

4. The high-permeability ferrite-based stainless steel according to claim 1, wherein a magnetic permeability is 1200 or more when a magnetic field of 10000 A/m is applied at a frequency of 50 Hz.

5. The high-permeability ferrite-based stainless steel according to claim 1, wherein a yield strength is 280 MPa or more.
